(19) United States
(12) Patent Application Publication
(10) Pub. No.: US 2015/0067144 A1
(43) Pub. Date: Mar. 5, 2015

(54) Method and System for Detecting Network Printers without Prior Knowledge of Network Topology

(71) Applicant: Stephen Kent Scovill, Ocala, FL (US)

(72) Inventor: Stephen Kent Scovill, Ocala, FL (US)

(21) Appl. No.: 14/017,287

(22) Filed: Sep. 3, 2013

(51) Int. Cl. H04L 12/26

(52) U.S. Cl. CPC H04L 43/065
USPC 709/224

(57) ABSTRACT

In one example, we describe a method and system for detecting network printers without any knowledge of the network topology. Discovery (our solution) uses three different utilities: Discover Computers runs on a domain attached computer, with a domain user account. It queries AD (Directory Services) and gets lists of users, groups, and computers. The computer list is then used by Discover Ranges. Discover Ranges uses Computers.txt and queries the DNS for the IP addresses. It builds a list of IP addresses used by Discover Printers. Discover Printers uses IPRanges.csv, and with 40 threads, opens port 9100 on each IP address. When successful, it then requests web page(s) to determine manufacturer and model for each device. The end result is UnivDriverlmport.csv, which is directly importable into the Universal PS Driver Wizard in the output management module. Other details and variations are also presented here.

### RELATED APPLICATIONS

This application is related to (1) U.S. Provisional Patent Application Ser. No. 61/648,949, filed May 18, 2012, (2) U.S. Provisional Patent Application Ser. No. 61/648,957, filed May 18, 2012, (3) U.S. Provisional Patent Application Ser. No. 61/648,941, filed May 18, 2012, (4) U.S. patent application Ser. No. 13/843,652 filed 15 Mar. 2013, (5) U.S. patent application Ser. No. 13/843,586 filed 15 Mar. 2013, and (6) U.S. patent application Ser. No. 13/843,502 filed 15 Mar. 2013, each of which is incorporated by reference herein in its entirety.

### BACKGROUND OF THE INVENTION

In a network of computers and printers, for example, a user or the system needs to know the available resources and devices in the network, e.g., the network printers. However, one may not have the access to the network topology and connectivity beforehand. Discovery (our solution presented here) detects network printers without any knowledge of the network topology. It does not generally work for all networks. For example, a highly secured network would not be discoverable.

Some of the prior art are:

EP 1551133 B1—Printer discovery protocol system and method

EP 2365431 A3—Printer discovery within a web page

EP 0756400 A2—Method for discovering and aging a printer in a network

EP 2003542 A1—Universal print driver with best fit discovery

U.S. Pat. No. 7,707,312 B2—Printer discovery protocol system and method

US 20100161783 A1—Socket connection-based printer discovery method using a thread management scheme

U.S. Pat. No. 8,330,984—For the discovery of printers on a network

WO 2007136622 A2—Mechanism to convey discovery information in a wireless network

However, the invention and embodiments described here, below, have not been addressed or presented in any single or combination of prior art.

### SUMMARY OF THE INVENTION

In one embodiment, we describe a method and system for detecting network printers without any knowledge of the network topology. That is how it works:

Discovery (our solution) uses three different utilities:
Discover Computers runs on a domain attached computer, with a domain user account. It queries AD (Directory Services) and gets lists of users, groups, and computers. The computer list is used by Discover Ranges.
Discover Ranges uses the computer list and queries the DNS (Domain Name System) for the IP (Internet Protocol) addresses. It need not run on a domain attached computer. It only needs access to the DNS. It builds a list of IP addresses used by Discover Printers, and builds a list of IP address ranges.
Discover Printers uses the IP address ranges, and with multiple threads (for example, 40), attempts to connect to the device using SNMP. If successful, it then queries for manufacturer and model for each device. If unsuccessful, Discover Printers opens port 9100 on each IP address. When successful, it then requests web page(s) to determine manufacturer and model for each device. It need not run on a domain attached computer. The Web Spyder and search algorithms are manufacturer-dependent. The end result is a list of printer IP addresses, manufacturers, and models.

Other details and variations on system and method are also presented here.

### BRIEF DESCRIPTION OF THE DRAWINGS

FIG. 1 is for one embodiment, as an example, for printers and a network.

FIG. 2 is for one embodiment, as an example, for device or system with print driver and multiple applications.

FIG. 3 is for one embodiment, as an example, for using user interface with query for status and IP addresses.

FIG. 4 is for one embodiment, as an example, for using user interface with printer nickname, favorite printer, and default printer.

FIG. 5 is for one embodiment, as an example, for using user interface with available printers, universal print driver, and specific print driver.

FIG. 6 is for one embodiment, as an example, for using user interface with available printers, printer list, selection criteria, printer selection, and best fit printers.

FIG. 7 is for one embodiment, as an example, for device or system with print driver, link to printer, and link to network.

FIG. 8 is for one embodiment, as an example, for Discovery module.

FIG. 9 is for one embodiment, as an example, for Discovery method.

FIG. 10 is for one embodiment, as an example, for device or system with IP/MAC addresses and link to DHCP.

FIG. 11 is for one embodiment, as an example, for device or system with age of components information database and repair scheduling.

FIG. 12 is for one embodiment, as an example, for a system with accounting and billing modules.

FIG. 13 is for one embodiment, as an example, for a system with analyzing module working with templates and models databases.

### DETAILED DESCRIPTION OF THE PREFERRED EMBODIMENTS

In one embodiment, we describe a method and system for detecting network printers without any knowledge of the network topology. That is how it works:

Discovery (our solution) uses three different utilities:
Discover Computers runs on a domain attached computer, with a domain user account. It queries AD (Directory Services) and gets lists of users, groups, and computers. The computer list is used by Discover Ranges.
Discover Ranges uses the computer list and queries the DNS (Domain Name System) for the IP (Internet Protocol) addresses. It need not run on a domain attached computer. It only needs access to the DNS. It builds a list of IP addresses used by Discover Printers, and builds a list of IP address ranges.
Discover Printers uses the IP address ranges, and with multiple threads (for example, 40), attempts to connect to the device using SNMP. If successful, it then queries for manufacturer and model for each device. If unsuccessful, Discover Printers opens port 9100 on each IP address. When successful, it then requests web page(s) to determine manufacturer and model for each device. It need not run on a domain attached computer. The Web Spyder and search algorithms are manufacturer-dependent. The end result is a list of printer IP addresses, manufacturers, and models.

The example of use cases are:
Pre-Sales: Gives information about network users, groups, computers, and printers.
Installation: Should result in a faster installation with fewer problems.

In one embodiment, we have Discovery based on an output management configuration method. For example, we have the following steps:
Run Discovery.
Install the output management, which is built on a scalable platform, capable of handling output management for organizations with license, activate, authorize, and setup file store.
Setup SNMP (Simple Network Management Protocol).
Optionally, import users.
Once Discovery has finished, import the UnivDriverlmport.csv file into the Universal PS Driver (e.g., HP Universal PostScript Print Driver) Wizard using “create devices/destinations”.
Now, in this phase, import the IPRanges.csv file into SNMP configuration, and run Detect. (In one embodiment, for phase 1, enter ranges by copy/paste.)
Let system run for a while (e.g., about 15 minutes) to allow SNMP updates to occur, or force an update thru SNMP.
Review newly-discovered devices (in Devices application, select each device). These will mostly be devices that do not have PS support. So, they will need to use different driver(s).
Select all destinations, and configure, review and adjust printer families.
For using web kiosk (or terminal or seat or access point or hub), select all devices, and configure and set the kiosk access.
In phase 2, deploy/configure MFP client(s) (e.g., Infrastructure Management Frame Protection).
Right-click on all destinations (security).
Add Windows group(s).
Assign destination security (e.g., the top three entries are all you need).
Tools/console security—
And finally, add Windows group(s)—Add kiosk right.

In one embodiment, we have a status indicator, which can use LED, light, sound, or text message or signal or warning, to notify the user or admin about the status of the printers in the network. In one embodiment, we have a device configured through the network, or a printer be re-configured remotely by a processor or other devices, or parameters be changed remotely by other devices.

In one embodiment, we have dynamic IP address by Dynamic Host Configuration Protocol. In one embodiment, we have static IP address for a specific device. In one embodiment, we have a centralized unit for the network. In one embodiment, we have an authentication module between communicating devices. In one embodiment, we have a list of pre-approved MAC addresses for communication with a specific device. In one embodiment, we have a secured/encrypted communication between devices.

In one embodiment, we have a monitoring module for monitoring printers on the network. It discovers, monitors, and produces reports for the printers in the network. In one embodiment, we have multiple passes for scanning the network for discovering the devices or collecting parameters from network devices or setting parameters for the devices.

In one embodiment, if the discovered printer is not familiar or not known, then the processor or system refers to a repository or central unit for more information. In one embodiment, we have parallel scans or monitoring. In one embodiment, we have serial scans or monitoring. In one embodiment, we have print count information gathered from printers. In one embodiment, we have service scheduling or repair requests or age record/life expectancy for components information gathered from printers. In one embodiment, we have service scheduling reported to the central unit or admin or user.

In one embodiment, we have accounting module attached to each printer. In one embodiment, we have an accounting module communicating with all printers. In one embodiment, we have a billing module for users. In one embodiment, we have a printer setup module. In one embodiment, we have an initialization module.

In one embodiment, we have a centralized topology or configuration for the network. In one embodiment, the system guesses or estimates the topology of the network. In one embodiment, the system models the topology of the network, based on existing templates or models. In one embodiment, we have periodic scans or at specific intervals/times or at special events or based on specific conditions.

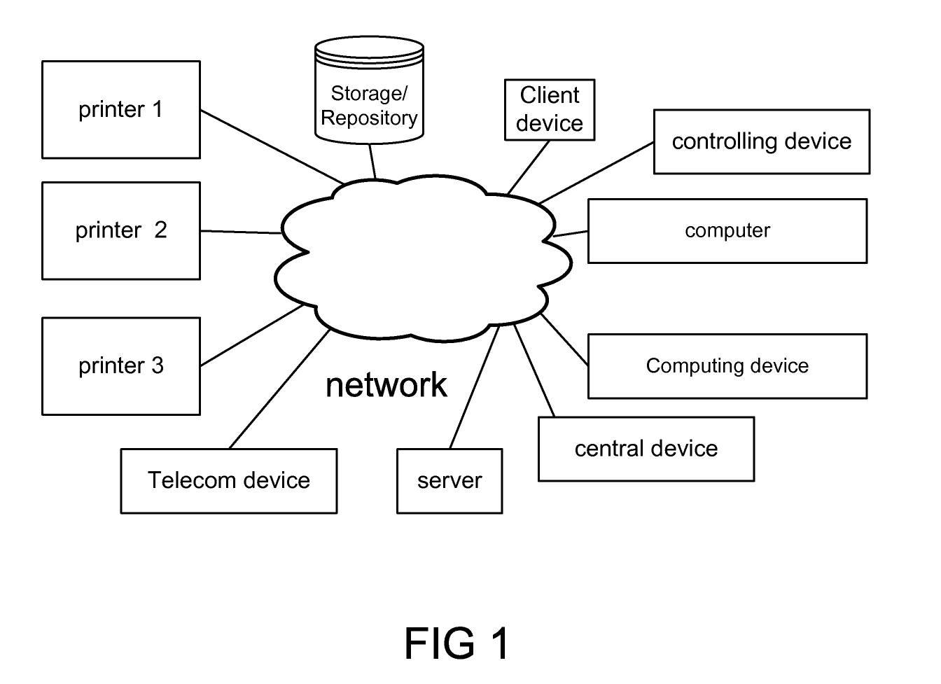

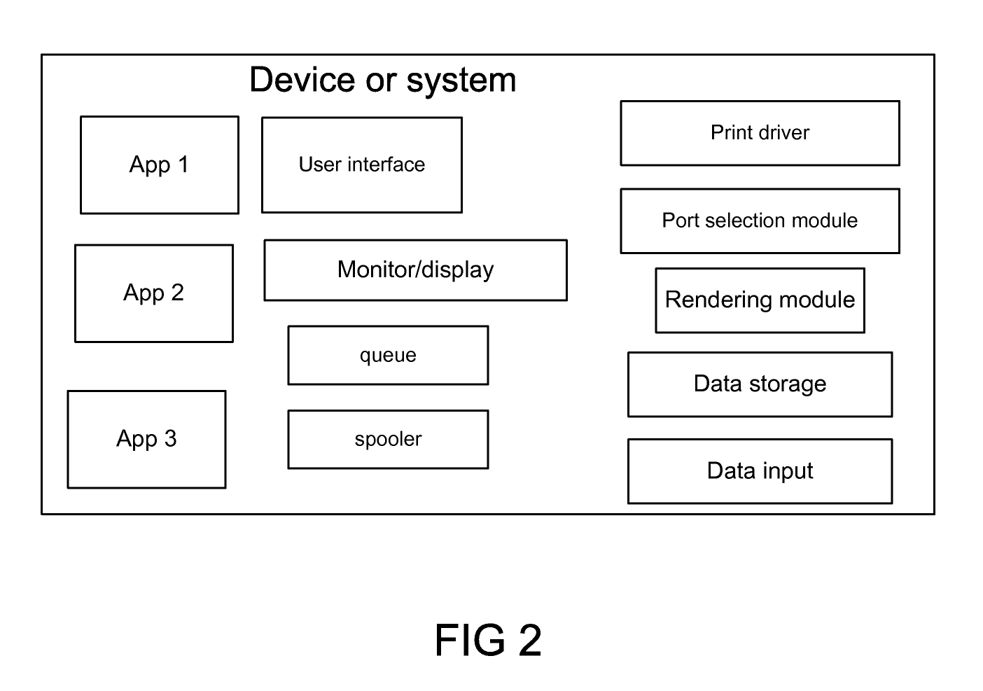

FIG. 1 is for one embodiment, as an example, for printers and a network, with controlling device and central device, to control the system. FIG. 2 is for one embodiment, as an example, for device or system with print driver and multiple applications, in addition to queue, spooler, port selection module, and rendering module, to (for example) route the print jobs or assign other tasks.

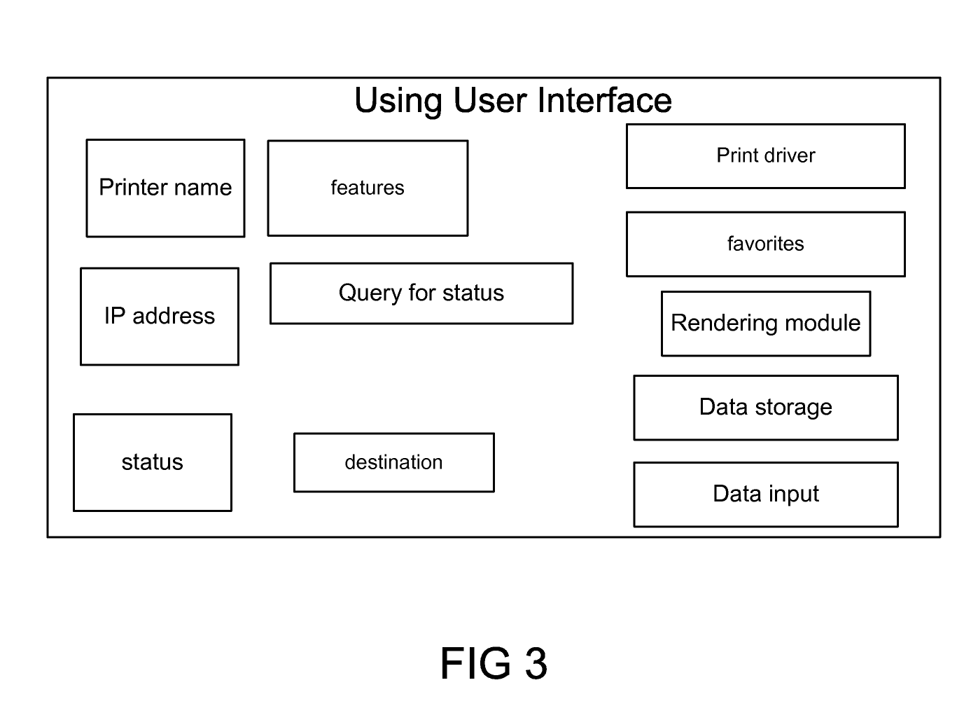

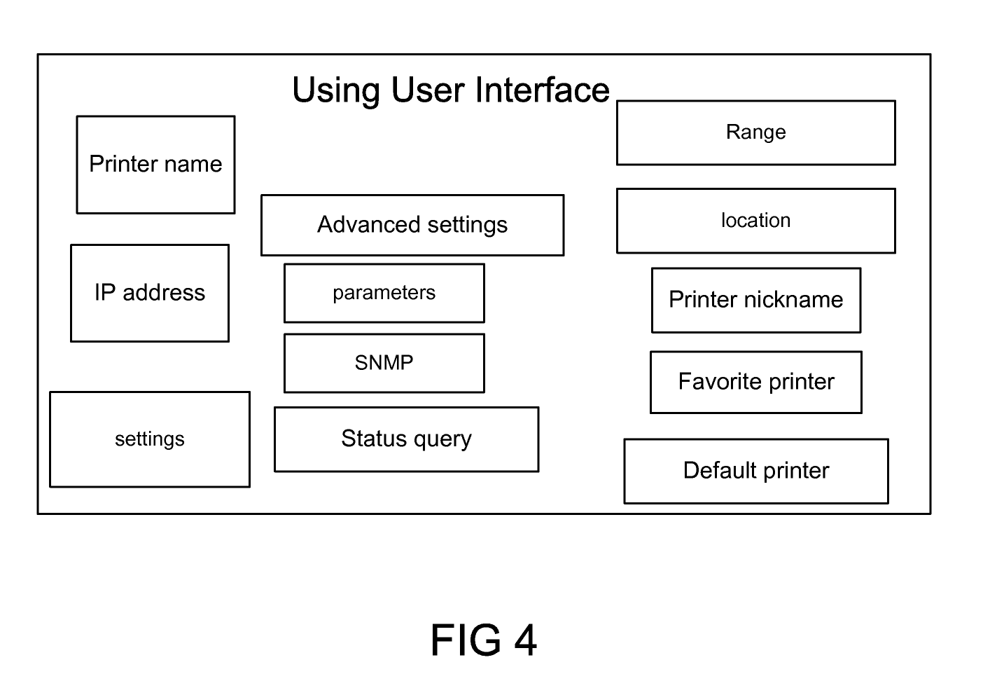

FIG. 3 is for one embodiment, as an example, for using user interface with query for status and features for IP addresses and printer names, to set the favorites or destinations, in relationship with print driver and rendering module. FIG. 4 is for one embodiment, as an example, for using user interface with printer nickname, favorite printer, and default printer, with respect to range, location, and IP addresses, for various settings and parameters, in accordance with SNMP and other protocols.

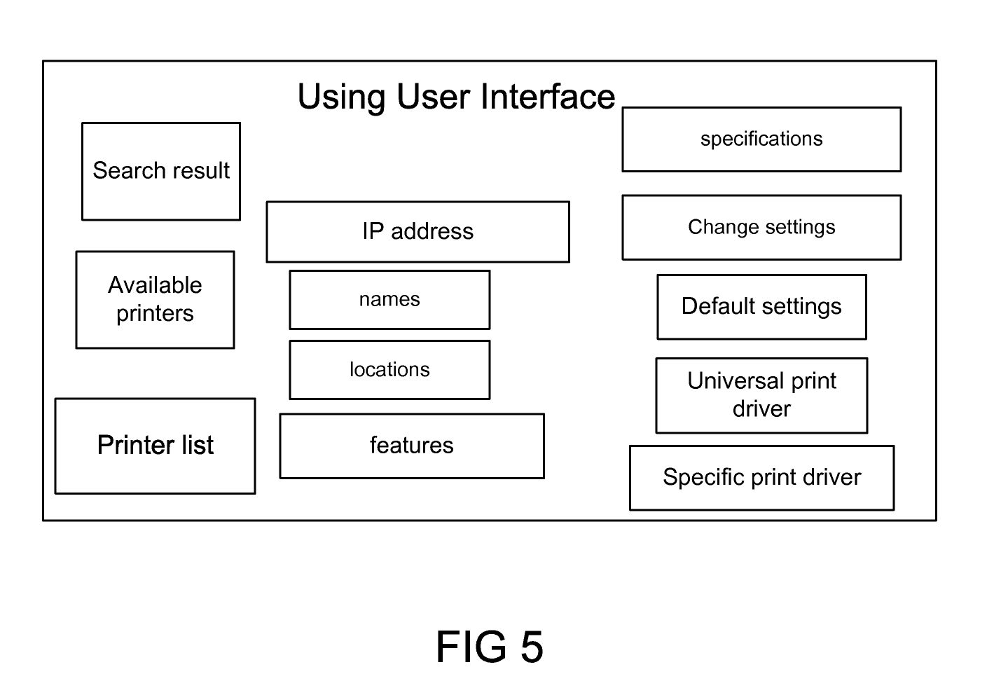

FIG. 5 is for one embodiment, as an example, for using user interface with available printers, universal print driver, and specific print driver, e.g., for choosing a print driver for a printer. It can change settings or use default settings, based on specifications or features. The printer list is based on IP address, name, and location, associated with search results, e.g., based on specifications or features.

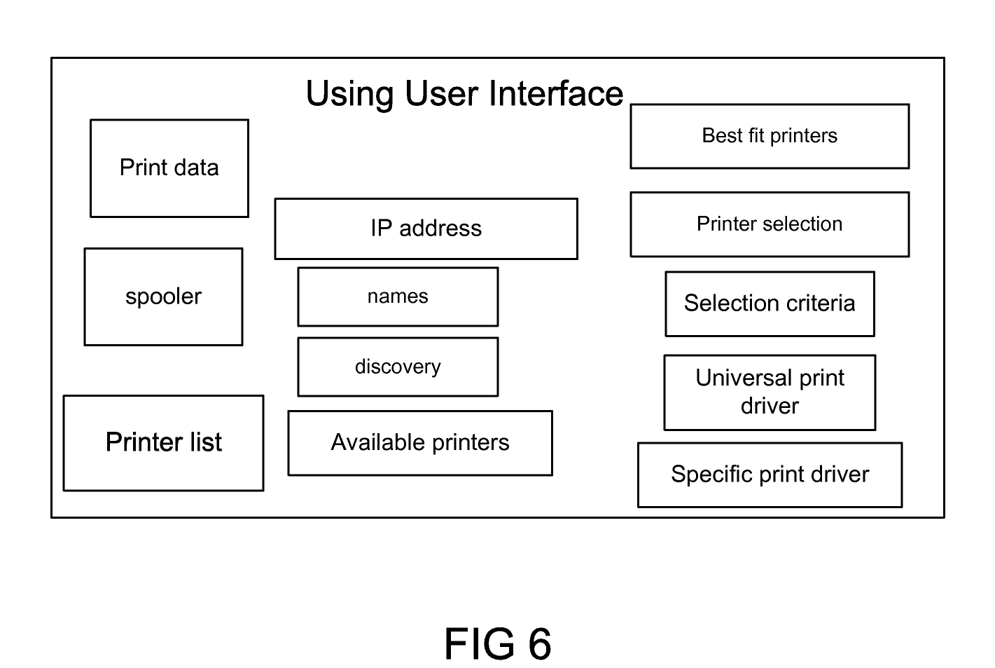

FIG. 6 is for one embodiment, as an example, for using user interface with available printers, printer list, selection criteria, printer selection, and best fit printers, for choosing a printer. It deals with universal print driver and specific print driver. It has a printer list and the available printers list, based on IP addresses and names. It also has a spooler. It does the discovery for the available printers.

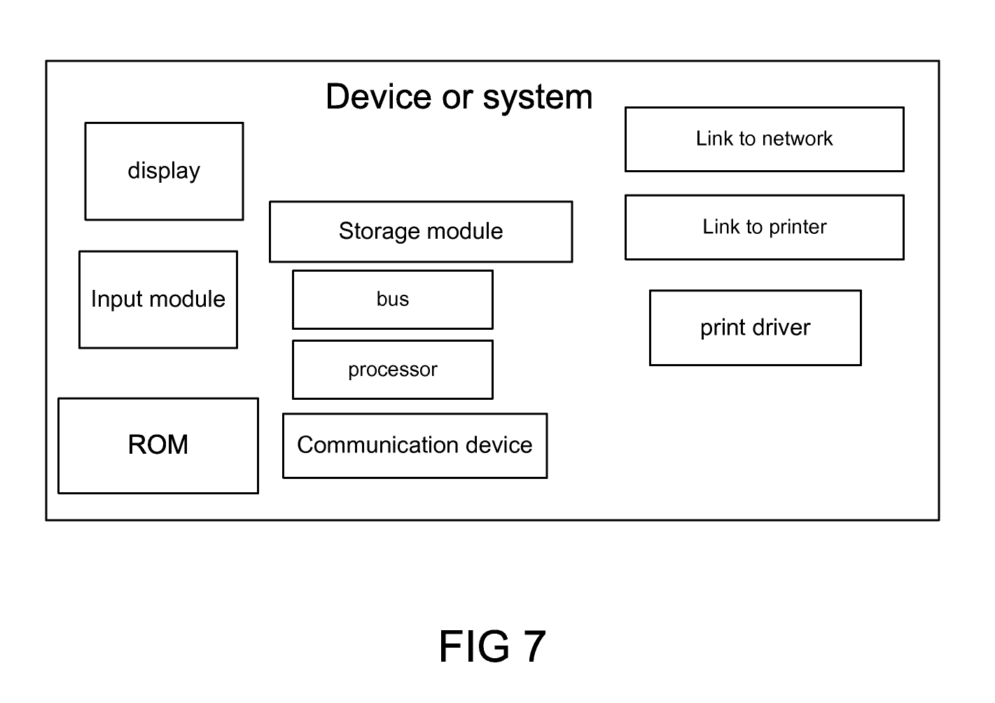

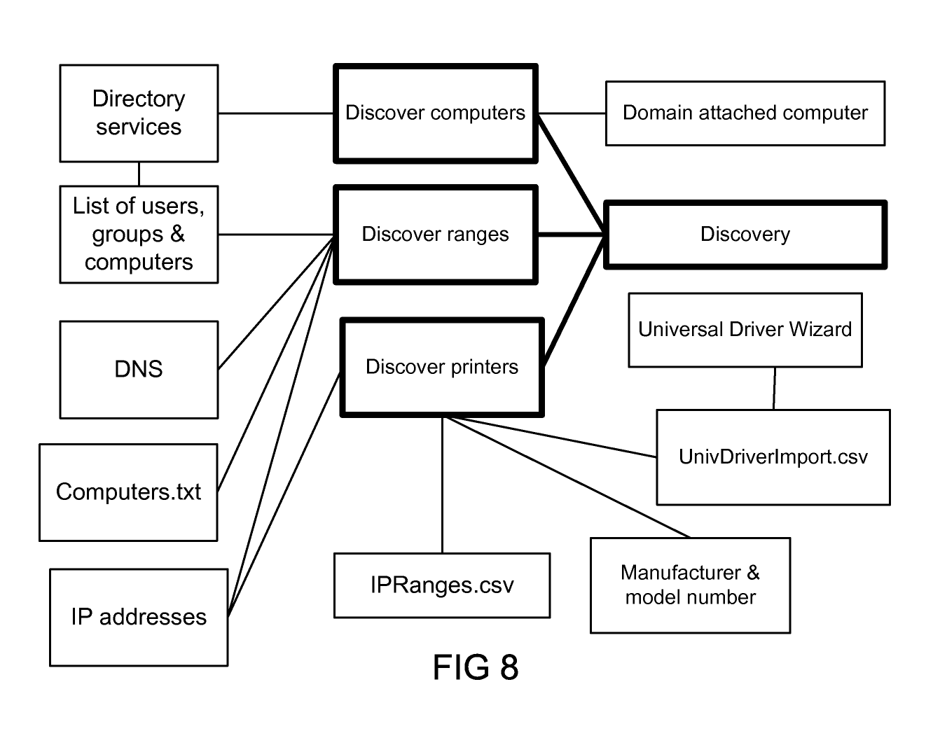

FIG. 7 is for one embodiment, as an example, for device or system with print driver, link to printer, and link to network, plus a processor for running the system. FIG. 8 is for one embodiment, as an example, for Discovery module, which applies Discover Computers, Discover Ranges, and Discover Printers, for discovery purpose for printers in a network.

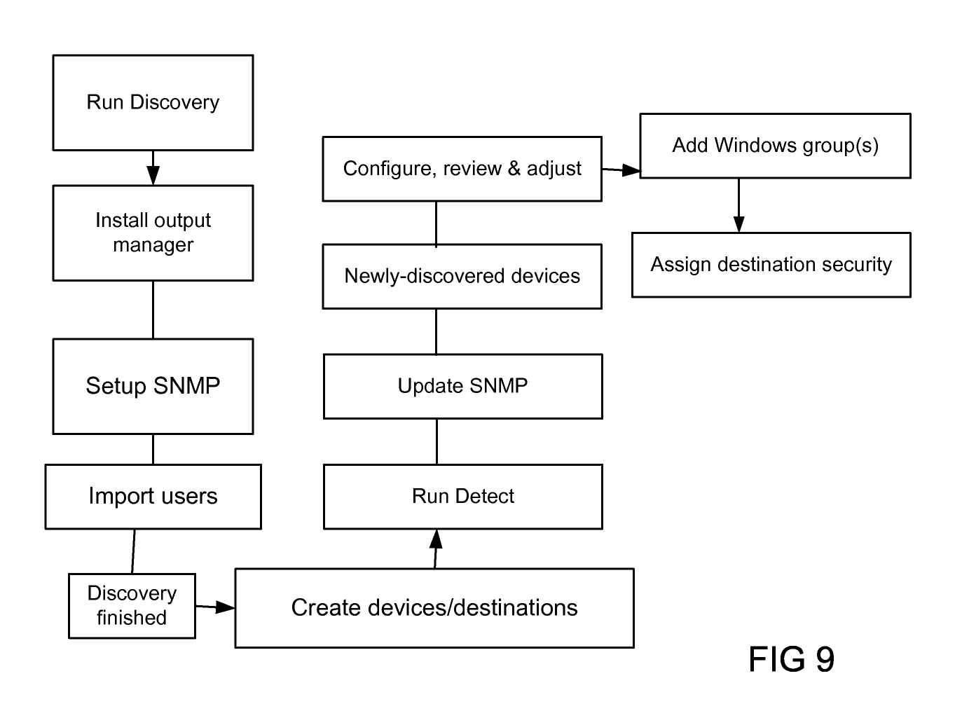

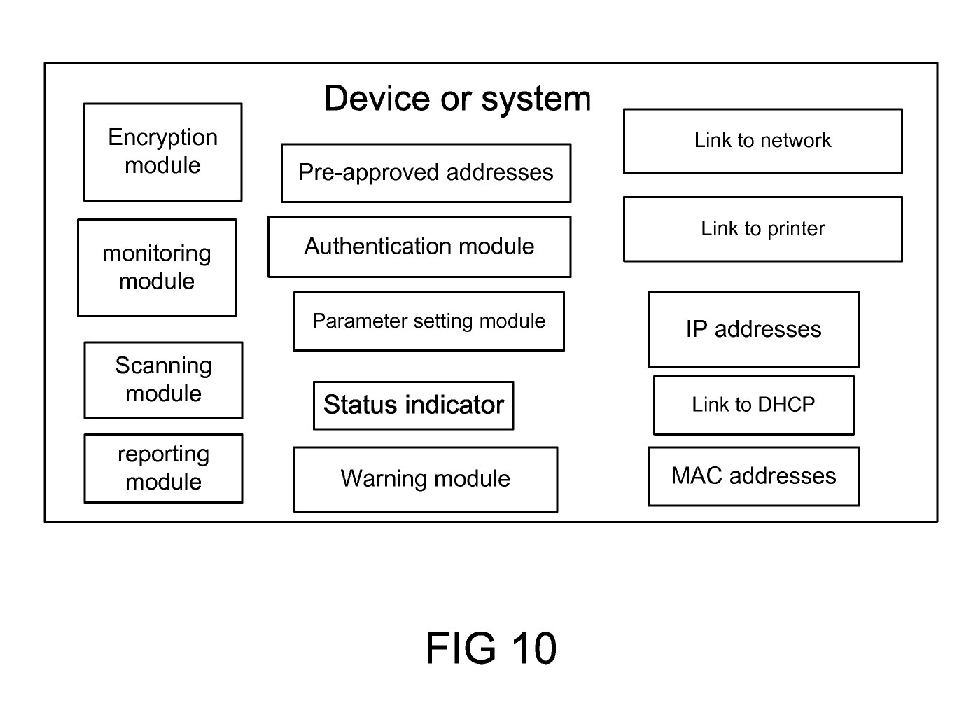

FIG. 9 is for one embodiment, as an example, for Discovery method for printers in a network. FIG. 10 is for one embodiment, as an example, for device or system with IP/MAC addresses and link to DHCP (Dynamic Host Configuration Protocol). It has the scanning, monitoring, and reporting modules. It also has encryption module for secure transmissions. It has the authentication module for providing the pre-approved addresses, as an example. It has a parameter setting module. It also has a status indicator and warning module to inform the admin or user about the status. It can link to the printers and the network.

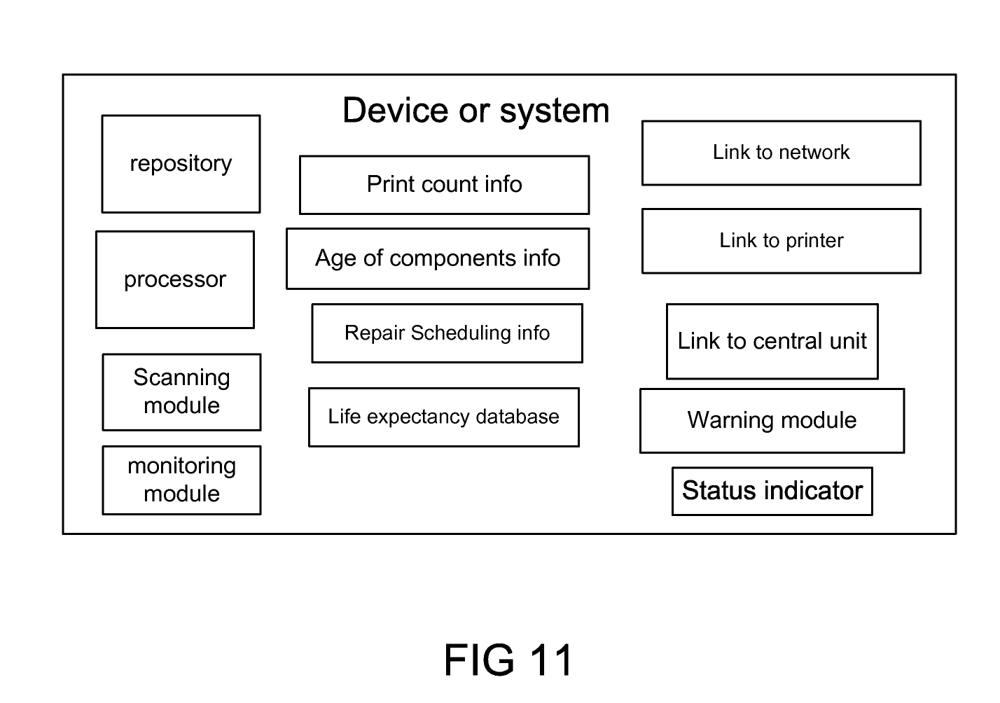

FIG. 11 is for one embodiment, as an example, for device or system with age of components information database and repair scheduling, based on life expectancy database, with corresponding warning and status modules for the user or admin or central unit. It also scans and monitors the network. It gathers the information about the print count, as well as other functions of the printer, so that it can charge the proper customer with the right amount, on a weekly, monthly, or periodic basis. It can charge the customer as an aggregate amount for multiple print jobs or processed documents. It also has a processor for controlling the system and calculations. It includes one or more repositories for storage of files and data.

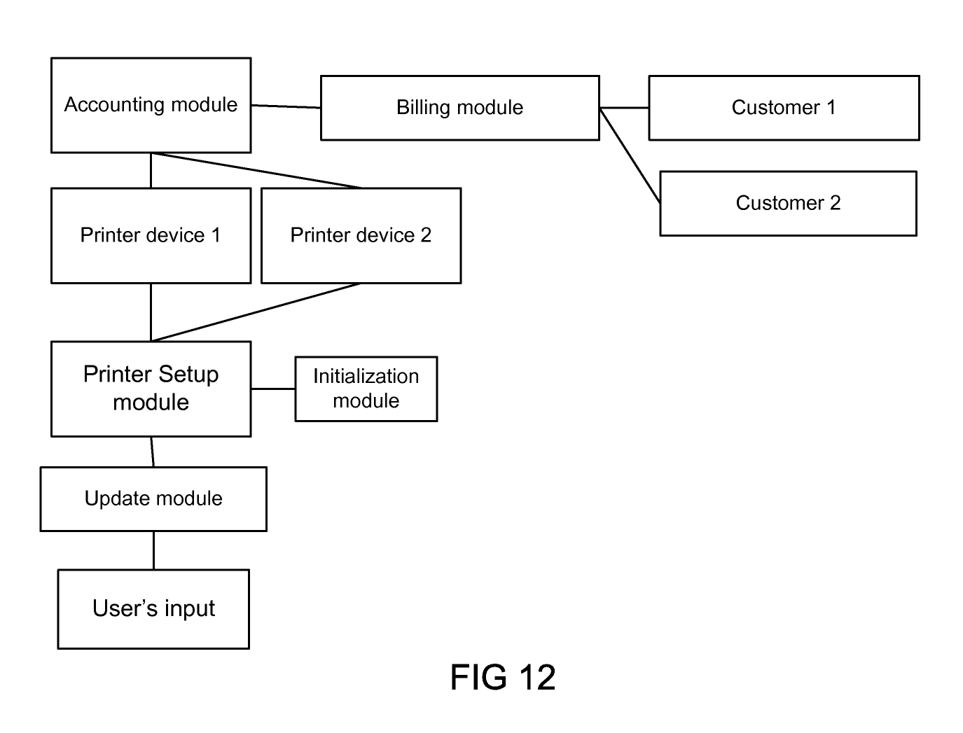

FIG. 12 is for one embodiment, as an example, for a system with accounting and billing modules, to charge customers, based on multiple printers. The printers are setup or initialized using, e.g., user's input and updated files.

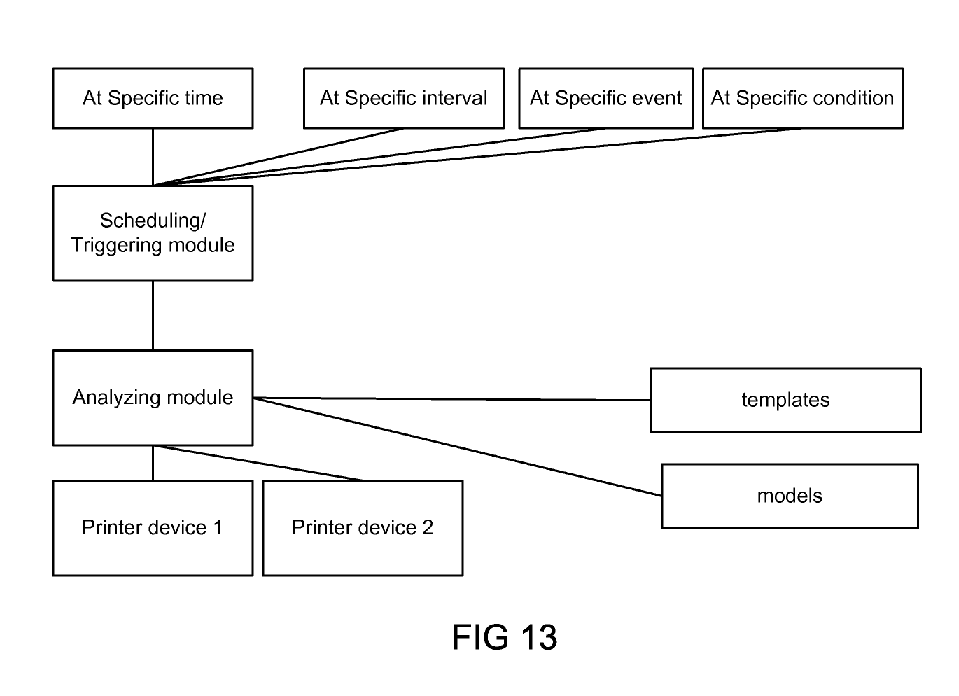

FIG. 13 is for one embodiment, as an example, for a system with analyzing module working with templates and models databases, to analyze the network to model the topology, based on basic or simpler templates and models. The scheduling and triggering event to act on analyzer module is based on one or more of the following factors or parameters:
At a specific time
At a specific interval
At a specific event
At a specific condition (if the condition is satisfied, e.g., using IF-THEN rule(s))

Implementations of the invention may be made in hardware, firmware, software, or any suitable combination thereof. The invention may also be implemented as instructions stored on a machine-readable medium that can be read and executed on one or more processing devices. For example, the machine-readable medium may include various mechanisms that can store and transmit information that can be read on the processing devices or other machines (e.g., read only memory, random access memory, magnetic disk storage media, optical storage media, flash memory devices, or any other storage or non-transitory media that can suitably store and transmit machine-readable information). Furthermore, although firmware, software, routines, or instructions may be described in the above disclosure with respect to certain exemplary aspects and implementations performing certain actions or operations, it will be apparent that such descriptions are merely for the sake of convenience and that such actions or operations in fact result from processing devices, computing devices, processors, controllers, or other hardware executing the firmware, software, routines, or instructions. Moreover, to the extent that the above disclosure describes executing or performing certain operations or actions in a particular order or sequence, such descriptions are exemplary only and such operations or actions may be performed or executed in any suitable order or sequence.

Furthermore, we can have server, PC, computing device, processor, microprocessor, mobile device, computer, central processor, distributed processing system, cloud computing, remote processor, or the like, for processing the data and calculation purposes in the teachings above. We also can have RAM, ROM, memory unit, storage, optical disc, CD, magnetic disc, buffer, or the like, for the storage of the data. We can have wireless communication, cable, optical communication, wired, telephonic, electrical, or the like, for modes of communications. We can have ink jet printer, laser printer, ribbon printer, solid source printer, or the like, for the printing devices. We can have commands between components in any high level or low level format or computer language or code.

Any variations of the above teaching are also intended to be covered by this patent application.

1. A method for detecting a network printer without a prior knowledge of network topology, said method comprising:
a domain-attached computer running a discover-computer utility module, with a domain-user account, in a computer or communication network;
querying a directory services database;
getting one or more lists of users, groups, and computers;
a discover-ranges utility module receiving said one or more lists of users, groups, and computers;
said discover-ranges utility module analyzing said one or more lists of users, groups, and computers;
said discover-ranges utility module querying a domain name system database for one or more Internet protocol addresses;
a processor device building a list of said one or more Internet protocol addresses;
a discover-printer utility module receiving said list of said one or more Internet protocol addresses;
said discover-printer utility module analyzing said list of said one or more Internet protocol addresses;
using a network management protocol to determine a manufacturer and a model number for each device in said computer or communication network;
if said determination of said manufacturer and said model number is unsuccessful, then opening a port for each of said one or more Internet protocol addresses;
requesting a web page to determine said manufacturer and said model number for each device in said computer or communication network;
said processor device recording said manufacturer and said model number for each device in said computer or communication network, in a first memory device.

2. A method for detecting a network printer without a prior knowledge of network topology, said method comprising:
a domain-attached computer running a discover-computer utility module, with a domain-user account, in a computer or communication network;
querying a directory services database;
getting one or more lists of users, groups, and computers;
a discover-ranges utility module receiving said one or more lists of users, groups, and computers;
said discover-ranges utility module analyzing said one or more lists of users, groups, and computers;
said discover-ranges utility module querying a domain name system database for one or more Internet protocol addresses;
a central device building a list of said one or more Internet protocol addresses;
a discover-printer utility module receiving said list of said one or more Internet protocol addresses;
said discover-printer utility module analyzing said list of said one or more Internet protocol addresses;
using a network management protocol to determine a manufacturer and a model number for each device in said computer or communication network;
if said determination of said manufacturer and said model number is unsuccessful, then opening a port for each of said one or more Internet protocol addresses;
requesting a web page to determine said manufacturer and said model number for each device in said computer or communication network;
said central device recording said manufacturer and said model number for each device in said computer or communication network, in a first memory device.

3. The method for detecting a network printer without a prior knowledge of network topology as recited in claim 1, said method comprises:
installing an output manager.

4. The method for detecting a network printer without a prior knowledge of network topology as recited in claim 1, said method comprises:
handling an output management module.

5. The method for detecting a network printer without a prior knowledge of network topology as recited in claim 1, said method comprises:
setting up a network management protocol.

6. The method for detecting a network printer without a prior knowledge of network topology as recited in claim 1, said method comprises:
importing one or more user names.

7. The method for detecting a network printer without a prior knowledge of network topology as recited in claim 1, said method comprises:
using a universal print driver.

8. The method for detecting a network printer without a prior knowledge of network topology as recited in claim 1, said method comprises:
updating network management protocols.

9. The method for detecting a network printer without a prior knowledge of network topology as recited in claim 1, said method comprises:
reviewing newly-discovered devices.

10. The method for detecting a network printer without a prior knowledge of network topology as recited in claim 1, said method comprises:
selecting one or more destinations.

11. The method for detecting a network printer without a prior knowledge of network topology as recited in claim 1, said method comprises:
configuring or adjusting printer families.

12. The method for detecting a network printer without a prior knowledge of network topology as recited in claim 1, said method comprises:
scheduling a repair.

13. The method for detecting a network printer without a prior knowledge of network topology as recited in claim 1, said method comprises:
counting print jobs.

14. The method for detecting a network printer without a prior knowledge of network topology as recited in claim 1, said method comprises:
accounting for print jobs.

15. The method for detecting a network printer without a prior knowledge of network topology as recited in claim 1, said method comprises:
billing for print jobs.

16. The method for detecting a network printer without a prior knowledge of network topology as recited in claim 1, said method comprises:
using a template or a model.

17. The method for detecting a network printer without a prior knowledge of network topology as recited in claim 1, said method comprises:
estimating or modeling a network topology.

18. The method for detecting a network printer without a prior knowledge of network topology as recited in claim 1, said method comprises:
producing reports for devices.

19. The method for detecting a network printer without a prior knowledge of network topology as recited in claim 1, said method comprises:
scanning said computer or communication network.

20. The method for detecting a network printer without a prior knowledge of network topology as recited in claim 1, said method comprises:
pre-approving addresses for devices.
